(19) United States
(12) Patent Application Publication
(10) Pub. No.: US 2022/0161368 A1
(43) Pub. Date: May 26, 2022

(54) VEGETATION EDGER WITH LASER AND METHOD

(71) Applicants: James C. Young, Fargo, ND (US); Maria Angelica Young, Fargo, ND (US)

(72) Inventors: James C. Young, Fargo, ND (US); Maria Angelica Young, Fargo, ND (US)

(21) Appl. No.: 17/531,675

(22) Filed: Nov. 19, 2021

Related U.S. Application Data
(60) Provisional application No. 63/118,276, filed on Nov. 25, 2020.

(51) Int. Cl. B23K 26/38; A01D 34/00; A01D 34/84

(52) U.S. Cl. CPC B23K 26/38; B23K 2103/36; A01D 34/84; A01D 34/006

(57) ABSTRACT

A cutting apparatus including a plurality of laser beams for cutting vegetation. The apparatus comprises a housing including side walls being extended generally perpendicular to form a downwardly oriented opening. An electrically powered laser cutting device is positioned centrally within the housing. A transport device is connectable to the housing to provide movement of the housing and laser cutting device along a surface covered by vegetation. The laser cutting device generates at least one laser beam that is directed downward underneath the housing.

### BACKGROUND

### 1. Field of Invention

The invention relates to an apparatus and method for cutting vegetation with a trimmer such as bushes, trees, and other similar plants. More specifically, the invention relates to an apparatus and method for cutting vegetation with focused laser beams in a trimmer.

### 2. Description of the Related Art

Prior trimmer devices include manually powered cutters, and electric and gasoline powered motors driving rigid, moving cutting blades operated by a series of drive spindles, belts, drive shafts, and gearing devices. Prior cutting blades require periodic sharpening of the blades and periodic replacement due to wear and tear cutting through thick wood and vegetation causes the blades. The power producing motors and cutting blades require speed limitations imposed by industry safety standards on the engine and/or blade rotation mechanisms to limit blade tip speeds as a function of the length of the mower blade as a safety measure for limiting the damages to adjacent objects or the operator when blades impact and shatter against hard objects. Commercial trimming operations would benefit from a cutting apparatus that incorporates a cutting means that does not use metal cutting means so as to minimize the chances of failures and injuries

The gasoline powered motors and rotating cutting blades are noisy when operated, and are relatively heavy and cumbersome to operate due to the weight of the motors, drive spindles, belts, chains, and rotating cutting blades. If adjustable heights of blades are needed to provide for a mulching effect, the rotating cutting blades must be maneuvered manually to a different cutting height, or multiple passes are required over the vegetation to produce smaller sized clippings for effective mulching of the vegetation.

One example of the prior art is U.S. Pat. No. 3,652,844, issued to Scott, Jr., which discloses a method and apparatus for destroying weeds and other plants by application of a pulsed laser beam directed onto vegetation by a diverging mirror arrangement. The laser beam is directed horizontally or vertically onto aquatic vegetation to be destroyed by a pulsed laser unit such as a N₂—CO₂—He laser focused onto an arrangement of mirrors adjusted by a mechanical means for focusing the laser beam. The weed destroying system produces cellular damage by build-up of heat within the aquatic vegetation on which the pulsed laser beam is focused.

A need exists in the vegetation control industry for a reliable, portable cutting apparatus that cuts vegetation at different heights during passage over the vegetation, that does not generate excess noise, and that includes a minimum of moving parts.

Therefore, it is an object of the present invention to provide a cutting means for cutting vegetation at different heights during rotation of the cutting means.

It is another object of the present invention to provide an apparatus having a cutting means rotatable at increasing speeds in proportion to the speed of the apparatus along the surface covered by vegetation.

It is another object of the present invention to provide an apparatus having a cutting means that includes a minimum of belts and rotating blades.

It is another object of the present invention to provide an apparatus having a cutting means that does not generate excess noise and minimizes use of moving blades.

It is another object of the present invention to provide a method for operating a cutting means for cutting vegetation at different heights during each passage of the cutting means.

It is another object of the present invention to provide a method for operating a cutting means for cutting vegetation into small clippings of different lengths for improved mulching of the cut vegetation.

### BRIEF SUMMARY OF INVENTION

An apparatus for cutting vegetation, and a method for operating the apparatus, is disclosed with the apparatus being controlled by a user for movement at variable ground speeds along a surface covered by vegetation for cutting the vegetation with a laser cutting means that is adjustable to project laser beams downward to the ground to allow the laser cutting apparatus. The apparatus comprises a housing including a first surface having side walls being extended generally perpendicular and downwardly from the first surface, the side walls having interior surfaces faced inwardly. The housing includes a second surface opposite the first surface, and includes a downwardly oriented opening bounded by the side walls. The cutting apparatus includes a laser cutting means being electrically powered, with the laser cutting means being positioned on the upper interior surfaces of the apparatus. The laser cutter means comprise at least one laser beam generation unit wherein the laser beam generated is directed downward to the ground.

A control means is positioned proximate to the housing with the laser cutting means being controlled by the control means for the strength, number of laser beams, and intensity of the laser beams. Electrical power is provided to the laser cutting means by a power means being detachably connected to the housing, with the power means preferably being powered by electricity directly from an outlet via an extension cord, rechargeable battery and/or a gasoline powered electrical generator.

A transport means is connectable to the housing, the transport means provides movement of the housing and the laser cutting means along the surface covered by vegetation. The transport means can include a push edger configuration having a plurality of wheels connectable to the housing, or a tractor platform having drive wheels and guide wheels, or a support frame and harness for attachment to the housing and for carrying by the user as a maneuverable hand-held vegetation cutting apparatus.

The laser cutting means includes at least one laser beam generator being located within or interior to the upper side of the housing on the upper portion of the housing with the laser beam generator being adjustable in strength, width, intensity and height. At least one laser beam is generated by the laser beam generator which is in operation while being operated by the user during cutting vegetation operations. The at least one laser beam can be directed to trim, cut, or otherwise remove vegetation proximate the lower opening of the housing. A plurality of light absorbing materials are positioned against the interior of the side walls and the second surface to absorb errant laser beams generated by the at least one laser beam generator.

The control means includes an electrical interface positioned proximate to the upper surface of the housing, with the electrical interface providing user control of the movement, width, height, strength and intensity of the laser beam generator, providing user control of the intensity of the rotatable laser beam. A plurality of laser beams can be generated simultaneously by the laser beam generator or by separate laser beam generators with user manipulated controls being positioned proximate the position of the user in relation to the transport means.

The laser cutting means of the apparatus operates with reduced noise due to a lack of traditional blades and operates with a reduced number of moving mechanical parts thereby reducing maintenance requirements.

### BRIEF DESCRIPTION OF SEVERAL VIEWS OF DRAWINGS

The above-mentioned objects and advantages of the present invention are readily apparent from the description of the invention contained herein, and by reference to the claims, read together with the drawings in which:

FIG. 1 is a side view of an apparatus for cutting vegetation, illustrating a laser cutting means positioned within a housing of the present invention.

### DETAILED DESCRIPTION OF THE INVENTION

In accordance with the present invention, there are provided both an apparatus for improved cutting of vegetation, and a method for operating the apparatus. The cutting apparatus is movable by a user at various ground speeds along a surface covered by vegetation for cutting the vegetation with a laser cutting means that is adjustable to project focused laser beams outwards at a plurality of angles and heights for cutting and trimming vegetation. The method is using the laser generating device as a edger to remove vegetation in a desired geometric pattern from close proximity to other surfaces, such as pavement, roads, sidewalks, etc. The improved cutting apparatus includes a housing having a first surface with a perimeter being either circular or multi-sided. Attached to the perimeter is a generally continuous side wall, either circular or multi-sided. The side wall is extended generally perpendicular around the perimeter, and generally downward from the first surface.

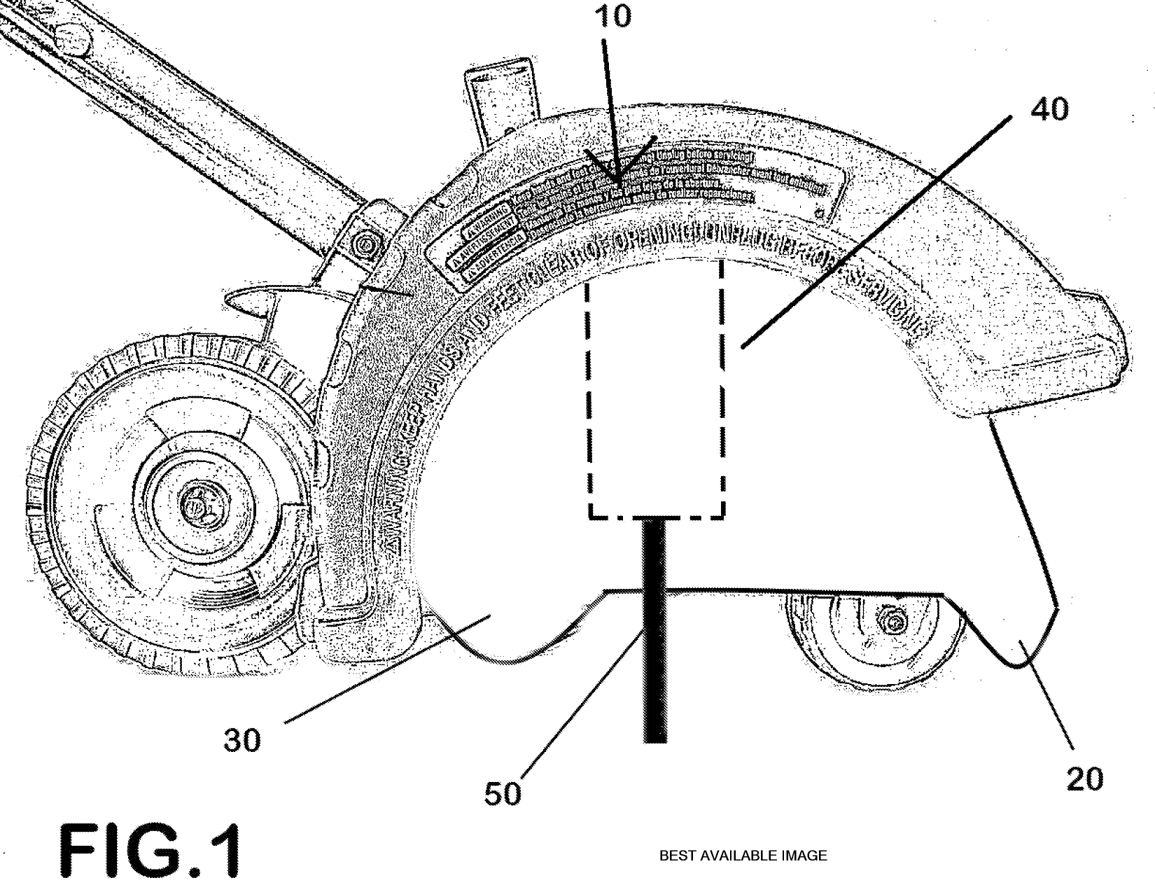

As seen in FIG. 1, the laser cutting apparatus has a housing protector, 10, connected to a front, 20, and back, 30, guide plate. The housing protector extends completely around the laser generation device, 40, and encloses it on all sides and top, while leaving the bottom open to allow the laser, 50, to exit the housing unit and cut vegetation. The at least one laser generating device, generates at least one laser, and the at least one laser generating device is attached to the upper portion of the housing protector. The interior surface of the housing protector can include a laser light absorbing material attached thereon for absorbing and containing errant laser beams. The housing protector may include an exterior surface opposite the interior surface and an interior opening that opens at a downwardly oriented opening bounded by the housing protector. The second surface can include a laser light absorbing material attached thereon. Further the housing protector may have at least one, and preferably more than one wheel, attached in order to allow the apparatus to be moved.

The cutting apparatus includes a laser cutting means, that can be electrically powered, with the laser cutting means being connectable to an interior side wall and extending downward from underneath the housing. The laser cutting means includes a laser beam generator and an end section being oriented a sufficient distance below the second surface to allow for at least one laser beam to be generated, and preferably at least two or more laser beams to be generated.

The at least one laser beam is transmitted generally from the end section of laser beam generator downward form the upper portion of the housing unit. Further, the apparatus may include a laser adjustment means which includes an adjustment means known to those skilled in the art for adjustments of the intensity, strength, and effective length of the at least one laser beam transmitted in the direction downward from the apparatus.

The at least one laser beam is generated by the laser beam generator which is continuously active in strength, intensity, height, width, and energy to act in a means to cut vegetation, while being controlled by the user during vegetation cutting operations. The at least one laser beam can be directed downward to the vegetation projecting into the lower opening of the housing. A plurality of light absorbing materials are positioned against the interior surfaces of the plurality of side walls and against the second surface to absorb errant laser light beams generated by the laser beam generator.

The at least one laser beam configuration can include alternative embodiments, including a second embodiment having at least two laser beam generators, or a third embodiment having three laser beam generators at a plurality of angles.

For the present invention, if the laser beams that are emitted at a plurality of angles from the cutting apparatus are misdirected by rocks or other reflective non-vegetative objects, the scattered laser beams are absorbed by the laser beam absorbing materials. Errant laser beams are contained within the housing and the laser beam(s) does not require limiting as a function of ground speed as a safety measure. Therefore, an advantage of the improved cutting apparatus is that when the transport means is accelerated in ground speed then the intensity of each laser beam can be increased in proportion to ensure that the vegetation contacted by the laser beams are cut at appropriate heights across a width of the cutting path no matter the ground speed of housing and laser beam generator.

The apparatus, as previous mentioned, may have a system control means that is positioned on the apparatus and may either be attached on the surface of the apparatus or attached on user operated control arms. The laser cutting means is controlled by electronic circuitry within, and/or connectable to, the system control means which measures ground speed of the transport mean, the directions of the laser beam(s), and other operating parameters of the laser beam generator. The user is able to override the circuitry to adjust the height, intensity, width, or strength of the at least one laser beam as the cutting apparatus is transported across the vegetation to be cut. The system control means can include a ground speed indicator and electrical circuitry that is known to those skilled in the art to adjust the height, intensity, width, or strength of the laser beams in proportion to changes in the ground speed of the cutting apparatus. If a plurality of laser beams is generated simultaneously by the laser beam generator, the user manipulated control means is positioned proximate to the position of the user in relation to the transport means.

Electrical power can be provided to the laser cutting means by an electrical power means being detachably connected to the housing, with the electrical power means being a plurality of rechargeable batteries, and/or an electrical generator operated by a power generation means that also provides power to drive the wheels of the tractor pulling the transport means. The electrical generator provides electrical power sufficient to operate the laser beam generator. For a plurality of batteries provided, the batteries may be rechargeable batteries known to those skilled in the art.

A transport means is connectable to the housing, the transport means provides movement of the housing and the laser cutting means along the surface covered by vegetation. The transport means can include a residential lawn and garden mowing tractor, a walk-behind, push mower configuration having a plurality of pairs of wheels connectable to the housing, or a commercial sized tractor having a gasoline powered engine, storage batteries, drive wheels, and a separate platform for supporting one or more laser beam generators.

The control means can include controls having a plurality of electrical and mechanical interfaces positioned proximate to the user operating position for each alternative embodiment. The electrical and mechanical interfaces provide user control of the intensity, energy and effective height of each laser

Electrical circuitry known to those skilled in the art can automatically increase the intensity of the laser beam generator as the ground speed of the transport means increases to increase the cutting strength of the laser beams in proportion to the speed of travel across the surface covered by vegetation.

The laser beams can be separately controlled by the electrical and mechanical interfaces to allow user adjustments for landscape changes as the transport means, housing(s) and laser beam generators moves along the surface covered by vegetation, thereby creating short and variable length clippings that provide improved aesthetics for the cut vegetation and improved mulching and decomposition of the cuttings. The laser cutting means of the cutting apparatus operates with reduced noise due to a lack of rotating cutting blades, and the potential to utilize a plurality of batteries for a power source. Additionally, the cutting apparatus operates with a reduced number of moving mechanical parts thereby reducing maintenance requirements imposed on the user.

A number of associated electronic and mechanical components known to those skilled in the art are not illustrated but can be incorporated without interfering with the objects and advantages of the present invention. An electrical generator can be sized appropriately to provide sufficient power to operate a plurality of laser beam generators in separate housings each having a plurality of laser beams projected radially outwards within each housing.

While a preferred embodiment is shown and described, it will be understood that it is not intended to limit the disclosure, but rather it is intended to cover all modification and alternate methods falling within the spirit and the scope of the invention as defined in the appended claims. One skilled in the art will recognize variations and associated alternative embodiments. The foregoing description should not be limited to the description of the embodiment of the invention contained herein.

What is claimed is:

1. An apparatus for cutting vegetation, the apparatus controlled by a user for movement along a surface covered by vegetation, said apparatus comprising:
a housing including a first surface and at least one side wall being extended generally perpendicular and downwardly from said first surface, said housing having a second surface being faced in an opposed direction from said first surface, said housing having an opening being positioned downwardly and being bound by said at least one side wall and at least one upper interior side wall, said opening being positioned proximate the vegetation being cut during operation;
a laser cutting means being powered and positioned on said upper interior side wall within said housing;
at least one laser beam being generated by said laser cutting means, said at least one laser beam being directed downward through the said opening during operation of said apparatus for cutting vegetation positioned proximate within said opening;
a control means positioned proximate said housing, said laser cutting means being controlled by said control means for intensity, strength, and effective height of said at least one laser beam;
a power means being detachably connected to said housing, said power means provides power to said laser cutting means; and
a transport means being connectable to said housing, said transport means being movable by the user at a variable speed along the surface covered by vegetation while said laser cutting means and at least one laser beam rotates within said housing.
